(19) United States
(12) Patent Application Publication
(10) Pub. No.: US 2026/0279006 A1
(43) Pub. Date: Sep. 17, 2026

(54) DEVICE AND METHOD OF CLASSIFYING BLOODSTAIN PATTERN USING DEEP LEARNING

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Young Il SEO, Wonju-si (KR); Hoyong YIE, Wonju-si (KR)

(21) Appl. No.: 19/259,061

(22) Filed: Jul. 3, 2025

(30) Foreign Application Priority Data
Mar. 12, 2025 (KR) 10-2025-0032244

(51) Int. Cl. G06V 10/764; G06V 10/26; G06V 10/774; G06V 10/776

(52) U.S. Cl. CPC G06V 10/764; G06V 10/26; G06V 10/774; G06V 10/776

(57) ABSTRACT

A bloodstain pattern classification method using deep learning according to one or more embodiments includes: obtaining a plurality of bloodstain images; classifying and labeling the obtained bloodstain images based on a predefined classification system; generating a bloodstain image database by storing the classified and labeled bloodstain images; extracting training data and validation data from the bloodstain image database and separating them according to a preset ratio; performing deep learning model training using the training data; performing validation of the trained deep learning model using the validation data; and performing pattern classification of the bloodstain images using the trained deep learning model, wherein the predefined classification system may include a classification system based on a formation mechanism of bloodstains or a morphological classification system of bloodstains.

### CROSS-REFERENCE TO RELATED APPLICATIONS

The present application is based on and claims priority to Korean Patent Application No. 10-2025-0032244, filed on Mar. 12, 2025, in the Korean Intellectual Property Office, which is incorporated herein by reference in its entirety.

### BACKGROUND

### 1. Field

One or more embodiments relate to a device and method of classifying bloodstain patterns using deep learning.

### 2. Description of the Related Art

A bloodstain is a stain formed when blood falls, splashes, or spreads on a surface or object. Bloodstains are not simple stains, but appear in various forms depending on the way blood flowed and environmental factors at the time.

In criminal cases, bloodstain pattern analysis (BPA) plays an important role in reconstructing the scene of a bloody incident and understanding the crime scene.

Bloodstain pattern analysis is conducted according to a methodology that includes distinguishing and observing bloodstain patterns, classifying bloodstain patterns, analyzing the dynamics of the bloodstains, and inferring and reconstructing actions based on the bloodstains. Inferring human behavior through bloodstain pattern analysis requires substantial experience and specialized forensic expertise.

Among the bloodstain pattern analysis operations, bloodstain pattern classification is one of the most important operations, and in the field of bloodstain pattern analysis, classifying and distinguishing various bloodstain patterns is a key task.

Scene reconstruction using bloodstain patterns involves analyzing the morphological characteristics of bloodstains formed by specific actions, classifying the bloodstains found at the scene based on these characteristics, and inversely estimating the actions that could have caused each bloodstain.

Currently, the entire bloodstain pattern analysis process is performed through expert knowledge and analysis, and this process has a problem that excessive manpower and time are required for accurate analysis.

Deep learning technology enables accurate identification of feature points in an image, thereby facilitating faster and more precise analysis of bloodstain patterns.

### SUMMARY

One or more embodiments include a device and method of classifying bloodstain patterns using deep learning, which reduce expert fatigue, increase analysis speed, and improve accuracy during field analysis through automatic classification of complex bloodstains.

According to one or more embodiments, a bloodstain pattern classification method using deep learning includes: obtaining a plurality of bloodstain images; classifying and labeling the obtained bloodstain images based on a predefined classification system; generating a bloodstain image database by storing the classified and labeled bloodstain images; extracting training data and validation data from the bloodstain image database and separating them according to a preset ratio; performing deep learning model training using the training data; performing validation of the trained deep learning model using the validation data; and performing pattern classification of the bloodstain images using the trained deep learning model, wherein the predefined classification system may include a classification system based on a formation mechanism of bloodstains or a morphological classification system of bloodstains.

In an embodiment, the bloodstain images may include an original bloodstain image and an extended bloodstain image.

In an embodiment, the extended bloodstain image is generated by dividing the original bloodstain image into a plurality of sections and applying an opacity filter to the divided bloodstain image.

In an embodiment, the bloodstain pattern classification method may further include outputting a result of the pattern classification of the bloodstain images.

In an embodiment, the bloodstain pattern classification method may include performing additional training of the trained deep learning model using an additional bloodstain image based on a validation result of the trained deep learning model.

In an embodiment, the classification system based on the formation mechanism of bloodstains may include: classification 1-1, which classifies a bloodstain into a spatter stain and a non-spatter stain; classification 1-2, which classifies the spatter stain according to a formation mechanism of gravity, external force dispersion, vascular pressure release, and cast-off, and classifies the non-spatter stain according to a formation mechanism of surface action and transfer; classification 1-3, which classifies a bloodstain caused by the gravity into a drip, drip trail, and “blood into blood”, classifies a bloodstain caused by the external force dispersion into an impact spatter stain and expectorate spatter, classifies a bloodstain caused by the vascular pressure release into a spurt, gush, splash pattern, and arterial spatter, classifies a bloodstain caused by the cast-off into a cast-off pattern, classifies a bloodstain caused by the surface action into a pool, flow pattern, and saturation stain, and classifies a bloodstain caused by the transfer into a contact stain; and classification 1-4, which classifies the impact spatter stain into a blunt impact spatter stain and a gun impact spatter stain, classifies the spurt into a wrist spurt and a carotid spurt, classifies the cast-off pattern into a swing cast-off pattern and a cessation cast-off pattern, wherein the cessation cast-off pattern is classified into a forward cessation cast-off pattern and a back cessation cast-off pattern, and classifies the contact stain into a pattern transfer, irregular pattern transfer, and smear, wherein the smear is classified into a wipe pattern and a swipe pattern.

In an embodiment, the morphological classification system of bloodstains may include: classification 2-1, which classifies a bloodstain into a spatter stain and a non-spatter stain according to bloodstain pattern features; classification 2-2, which classifies the spatter stain into a linear spatter and a non-linear spatter according to whether bloodstains are distributed linearly, and classifies the non-spatter stain into an irregular margin and regular margin according to whether the margins are regular; classification 2-3, which classifies the linear spatter into a spurt, swing cast-off pattern, drip trail, and cessation cast-off pattern (linear), classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains, classifies the irregular margin into a smear and a non-smear based on the presence or absence of a spatter stain or spine, wherein the non-smear is classified into “blood into blood”, a gush, and a splash pattern, and the smear is classified into a wipe pattern and a swipe pattern based on the presence or absence of a pre-existing bloodstain, and classifies the regular margin into a pattern transfer, saturation stain, flow pattern, pool, and irregular pattern transfer; and classification 2-4, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

According to one or more embodiments, a bloodstain pattern classification device using deep learning includes: at least one memory storing at least one instruction; and at least one processor, wherein the at least one processor is configured to execute the at least one instruction to: obtain a plurality of bloodstain images; classify and label the obtained bloodstain images based on a predefined classification system; generate a bloodstain image database by storing the classified and labeled bloodstain images; extract training data and validation data from the bloodstain image database and separate them according to a preset ratio; perform deep learning model training using the training data; perform validation of the trained deep learning model using the validation data; and perform pattern classification of the bloodstain images using the trained deep learning model, wherein the predefined classification system may include a classification system based on a formation mechanism of bloodstains or a morphological classification system of bloodstains.

According to an embodiment, the at least one processor is configured to execute the at least one instruction to: output results of the pattern classification of the bloodstain images.

According to an embodiment, the at least one processor is configured to execute the at least one instruction to: perform additional training of the trained deep learning model using an additional bloodstain image based on a validation result of the trained deep learning model.

A non-transitory computer-readable recording medium having recorded thereon a computer program according to an embodiment may execute a bloodstain pattern classification method using deep learning by using a computer.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration diagram of a bloodstain pattern classification device using deep learning, according to an embodiment;

FIG. 2 is a view of a classification system based on a formation mechanism of bloodstains;

FIG. 3 is a view of a morphological classification system of bloodstains;

FIG. 4 is a flowchart illustrating a bloodstain pattern classification method using deep learning, according to an embodiment; and

FIG. 5 is a view illustrating an output of a display according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various elements, these elements should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

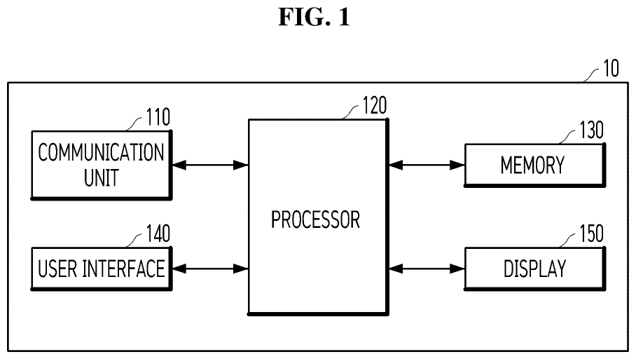

FIG. 1 is a schematic configuration diagram of a bloodstain pattern classification device using deep learning, according to an embodiment.

Referring to FIG. 1, a bloodstain pattern classification device 10 may include a communication unit 110, a processor 120, a memory 130, a user interface 140, and a display 150. The bloodstain pattern classification device 10 to which the disclosure is applied may be an information processing device used by a user. However, the disclosure is not limited thereto, and the bloodstain pattern classification device 10 may further include other components or some components may be omitted.

The bloodstain pattern classification device 10 may include at least one of a personal computer (PC), a laptop computer, a mobile phone, a tablet PC, a smart phone, a personal digital assistant (PDA), and a portable multimedia player (PMP).

The communication unit 110 is connected to the processor 120 and the memory 130 to transmit and receive data. The communication unit 110 may be connected to another external device to transmit and receive data. Hereinafter, the expression “transmitting and receiving A” may indicate transmitting and receiving “information or data representing A.”

The communication unit 110 may be implemented as circuitry within the bloodstain pattern classification device 10. For example, the communication unit 110 may include an internal bus and an external bus. As another example, the communication unit 110 may be an element that connects the bloodstain pattern classification device 10 to an external device. The communication unit 110 may be an interface. The communication unit 110 may receive data from an external device and transmit the data to the processor 120 and the memory 130. For example, the communication unit 110 may receive a bloodstain image from a photographing device.

The processor 120 may control operations of the bloodstain pattern classification device 10 according to an embodiment and perform logical operations.

The processor 120 processes data received by the communication unit 110 and data stored in the memory 130. The processor 120 may be a data processing device implemented in hardware having a circuit with a physical structure for performing desired operations. For example, desired operations may include code or instructions included in a program.

The processor 120 executes computer-readable code (e.g., software) stored in a memory (e.g., the memory 130) and instructions triggered by the processor 120.

The processor 120 controls the execution of a desired operation by executing at least one instruction stored in the memory 130. The at least one instruction may be stored in an internal memory included in the processor 120 or in the memory 130 included in a data processing device separately from the processor 120.

For example, the processor 120 may perform the following operations 210 to 280, which will be described in detail later.

The memory 130 stores data received by the communication unit 110 and data processed by the processor 120. The memory 130 may store a program (or application or software) that operates the bloodstain pattern classification device 10. The stored program may be coded to control the bloodstain pattern classification device 10 and may be executable by the processor 120.

The memory 130 may include a volatile memory such as static RAM (SRAM), dynamic RAM (DRAM) or synchronous DRAM (SDRAM), or a non-volatile memory such as a flash memory, phase-change RAM (PRAM), magnetic RAM (MRAM), resistive RAM (RRAM) or ferroelectric RAM (FRAM).

The user interface 140 may receive a user input for controlling the bloodstain pattern classification device 10. The user interface 140 may include, but is not limited to, a touch panel for detecting a user's touch, a button for receiving a user's push operation, a mouse or keyboard for specifying or selecting a point on a user interface screen, etc.

The user interface 140 may be, for example, at least one graphical user interface (GUI) provided for controlling the bloodstain pattern classification device 10.

The display 150 may display and output information processed in the bloodstain pattern classification device 10. For example, the display 150 may display a GUI for controlling the bloodstain pattern classification device 10.

The display 150 may be implemented as, but is not limited to, a liquid crystal display (LCD), a plasma display panel (PDP), an organic light emitting display (OLED), a field emission display (FED), an LED, a flexible display, a three-dimensional (3D) display, etc. Furthermore, the display 150 may be configured as a touch screen and used as an input device in addition to an output device.

In addition, in other embodiments, the bloodstain pattern classification device 10 may include more components than the components of FIG. 1. For example, the bloodstain pattern classification device 10 may further include other components such as a battery and charging device that powers internal components, a database, etc.

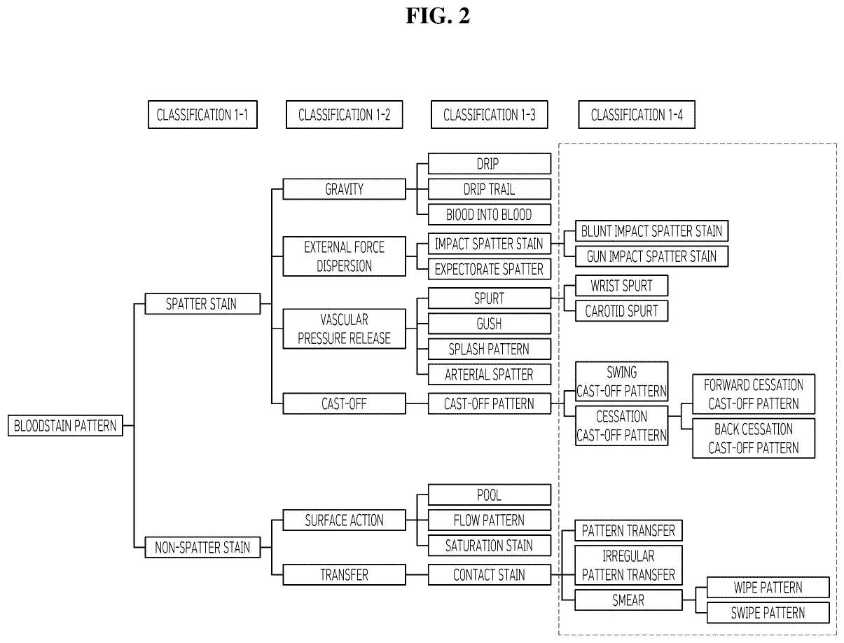

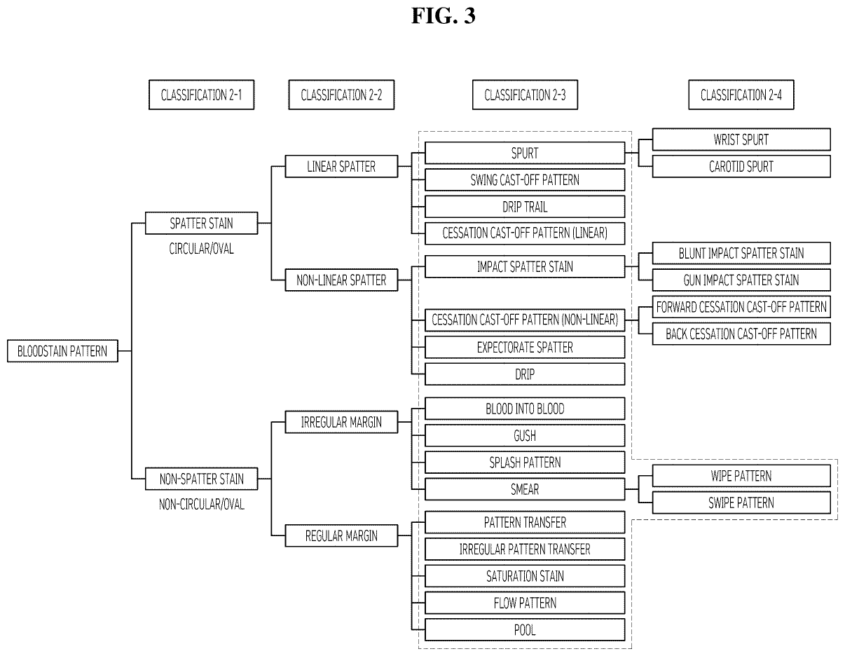

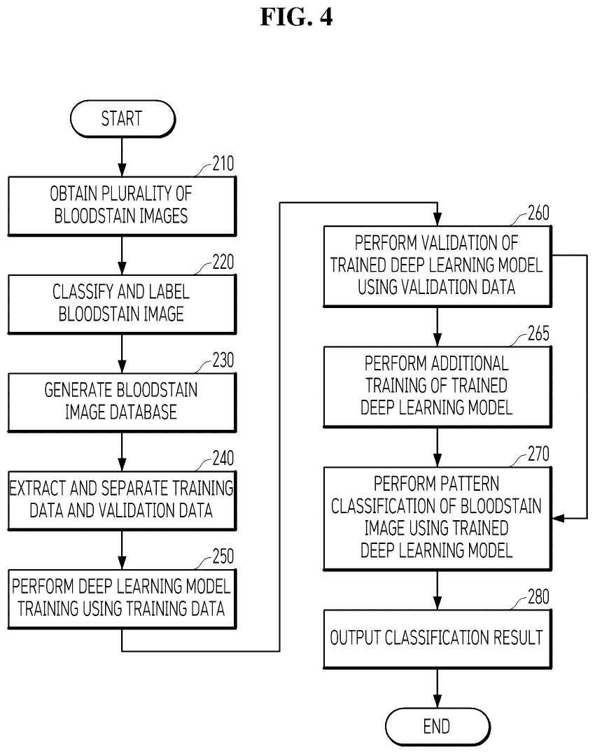

FIG. 2 is a view of a classification system based on a formation mechanism of bloodstains. FIG. 3 is a view of a morphological classification system of bloodstains. FIG. 4 is a flowchart illustrating a bloodstain pattern classification method using deep learning, according to an embodiment.

Referring to FIGS. 2 to 4, a bloodstain pattern classification method 20 using deep learning according to an embodiment will be described.

The following operations may be performed by the bloodstain pattern classification device 10 described above.

In operation 210, the bloodstain pattern classification device 10 may obtain a plurality of bloodstain images.

The bloodstain pattern classification device 10 may receive a plurality of bloodstain images obtained from a photographing device through the communication unit 110. In addition, the bloodstain pattern classification device 10 may include a camera including a lens and an image sensor. The image sensor may convert an image input by the lens into an electrical signal, and may be a semiconductor device such as a charge-coupled device (CCD) or a complementary metal oxide semiconductor (CMOS).

The plurality of bloodstain images may include an original bloodstain image and an extended bloodstain image.

The obtained bloodstain images may include real images captured by a camera, scanned document images, etc.

The obtained bloodstain images undergo a preprocessing process. The preprocessing process may include resizing, noise removal, brightness/contrast normalization, rotation/inversion correction, etc. of the bloodstain images. This is to improve the accuracy of subsequent classification tasks and ensure data consistency.

In addition, an extended bloodstain image may be generated for each original bloodstain image for more accurate classification. An extended bloodstain image may be generated through various transformations and processing based on the obtained original bloodstain image. The extended bloodstain image may be generated by rotating, resizing, color conversion, adding noise, etc. of the original bloodstain image.

According to an embodiment, the extended bloodstain image is generated by dividing the original bloodstain image into a plurality of sections and applying an opacity filter to the divided bloodstain image.

For example, the extended bloodstain image may be generated by applying, to the divided bloodstain image, a filter such as a full opacity filter, a one-way gradient opacity filter, or a two-way gradient opacity filter. In addition, the divided sections or an area formed by combining the divided sections may be stored in the database.

In operation 220, the obtained bloodstain image may be classified and labeled based on a predefined classification system.

The predefined classification system may be the classification system based on the formation mechanism of bloodstains or the morphological classification system.

Referring to FIG. 2, the classification system based on the formation mechanism of bloodstains may include the following classification 1-1, classification 1-2, classification 1-3, and classification 1-4.

Classification 1-1 may classify a bloodstain into a spatter stain and a non-spatter stain.

Classification 1-2 is subclassification of classification 1-1 and is as follows:

The spatter stain may be classified according to a formation mechanism of gravity, external force dispersion, vascular pressure release, and cast-off. The non-spatter stain may be classified according to a formation mechanism of surface action and transfer.

Classification 1-3 is subclassification of classification 1-2 and is as follows:

A bloodstain caused by gravity may be classified into a drip, drip trail, and “blood into blood”. A bloodstain caused by external force dispersion may be classified into an impact spatter stain and expectorate spatter. A bloodstain caused by vascular pressure release may classified into a spurt, gush, splash pattern, and arterial spatter. A bloodstain caused by cast-off may be classified into a cast-off pattern.

In addition, a bloodstain caused by surface action may be classified into a pool, flow pattern, and saturation stain. A bloodstain caused by transfer may be classified into a contact stain.

Classification 1-4 is subclassification of classification 1-3 and is as follows:

The impact spatter stain may be classified into a blunt impact spatter stain and a gun impact spatter stain. The spurt may be classified into a wrist spurt and a carotid spurt. The cast-off pattern may be classified into a swing cast-off pattern and a cessation cast-off pattern. The cessation cast-off pattern may be classified into a forward cessation cast-off pattern and a back cessation cast-off pattern. The contact stain may be classified into a pattern transfer, irregular pattern transfer, and smear. The smear may be classified into a wipe pattern and a swipe pattern.

Referring to FIG. 3, the morphological classification system of bloodstains may include the following classification 2-1, classification 2-2, classification 2-3, and classification 2-4.

Classification 2-1 may classify a bloodstain into a spatter stain and a non-spatter stain according to bloodstain pattern features.

Classification 2-2 is subclassification of classification 2-1 and is as follows:

The spatter stain may be classified into a linear spatter and a non-linear spatter according to whether bloodstains are distributed linearly. The non-spatter stain may be classified into an irregular margin and regular margin according to whether the margins are regular.

Classification 2-3 is subclassification of classification 2-2 and is as follows:

The linear spatter may be classified into a spurt, swing cast-off pattern, drip trail, and cessation cast-off pattern (linear).

The non-linear spatter may be classified into a non-drip and a drip based on the presence or absence of radial distribution. The non-drip may be classified into an expectorate spatter and a non-expectorate spatter based on the presence or absence of small rings and bubbles. The non-expectorate spatter may be classified into an impact spatter stain and a cessation cast-off pattern (non-linear) based on the presence or absence of circular or oval bloodstains.

The irregular margin may be classified into a smear and a non-smear based on the presence or absence of a spatter stain or spine. The non-smear may be classified into “blood into blood”, a gush, and a splash pattern. The smear may be classified into a wipe pattern and a swipe pattern based on the presence or absence of a pre-existing bloodstain.

The regular margin may be classified into a pattern transfer, saturation stain, flow pattern, pool, and irregular pattern transfer.

Classification 2-4 is subclassification of classification 2-3 and is as follows:

The spurt may be classified into a wrist spurt and a carotid spurt. The impact spatter stain may be classified into a blunt impact spatter stain and a gun impact spatter stain. The cessation cast-off pattern (non-linear) may be classified into a forward cessation cast-off pattern and a back cessation cast-off pattern.

Unclassified bloodstains that are not classified by the above classification systems include capillary action stains, blood clots, perimeter stains, voids, fly spots, ricochet stains, and altered stains.

Labeling may be performed on a bloodstain image classified by each of the classification systems as above.

Labeling is a process of identifying content and features of an image and tagging them in a machine-learnable form.

In operation 230, a bloodstain image database may be generated by storing the classified and labeled bloodstain image.

Classified and labeled bloodstain images may be stored in a hierarchical structure according to assigned classification system and label. Each bloodstain image is assigned a unique identifier, and metadata may be recorded together. For example, metadata may include classification information and labels of a bloodstain image, information about distinguishing between original/extended bloodstain images, preprocessing history, conversion information used for data expansion, and characteristic information (size, format, etc.) of a bloodstain image. Metadata facilitates searching, filtering, and management of database, and enables efficient data selection and utilization during a deep learning model training process.

Furthermore, the bloodstain image database may be designed to be easily extensible to facilitate the addition of new bloodstain images or classification systems.

In operation 240, training data and validation data may be extracted from the bloodstain image database and separated according to a preset ratio.

A sufficient amount of data is required for training a machine learning model, and this data is divided into training data and validation data. The training data is used for a model to learn patterns, and the validation data is used to evaluate the performance of a trained model.

Data suitable for training is extracted from the bloodstain image database.

Thereafter, the data is divided into training data and validation data according to a preset ratio (e.g., 80:20 or 70:30).

This process may be performed automatically without manual work, and may be applied by random sampling of data or according to specific criteria (e.g., maintaining class balance, etc.). This data division method may contribute to increasing the accuracy of training and preventing overfitting.

In operation 250, deep learning model training may be performed using the training data.

Deep learning is a field of machine learning that learns data using a multilayer neural network and automatically extracts features to recognize patterns. For example, deep learning models that can be applied to the embodiments include a convolutional neural network (CNN) and Residual Network (ResNet).

The training data may be input into a deep learning model, and weights may be optimized using a loss function and an optimizer.

The loss function may be measured by quantifying a difference (loss) between an actual value and a predicted value of the deep learning model. A weight and bias of the deep learning model are updated based on the loss function, and the optimizer (e.g., Adam or SGD) may optimize the model using gradient descent.

During the deep learning model training process, hyperparameters such as learning rate, batch size, and the number of epochs may be adjusted to derive optimal performance.

In operation 260, validation of the trained deep learning model may be performed using the validation data.

The performance of the model may be evaluated using validation data that was not used as training data. During the validation process, evaluation indices may be derived by comparing a predicted value output by the deep learning model with an actual correct value. Such evaluation indices may include accuracy, precision, recall, F1-score, and loss function values.

For example, deep learning model training is performed over 100,000 epochs using ResNet-101. The learning rate is set to 0.001, and validation may be performed in 10 cycles.

After operation 260 of performing validation of the trained deep learning model, the following operation 265 may be added.

In operation 265, based on a validation result of the trained deep learning model, additional training of the trained deep learning model may be performed using an additional bloodstain image.

The additional bloodstain image is a bloodstain image that was not used for training and validation.

In the additional training process, the performance of the model may be optimized by retraining the existing deep learning model using the additional bloodstain image. To this end, the additional bloodstain image may be used as training data after improving data quality through a preprocessing process.

In addition, according to an embodiment, instead of retraining the entire weights of the existing deep learning model, a fine-tuning method that tunes only the weights of a specific layer of the deep learning model may be applied.

In operation 270, pattern classification of a bloodstain image may be performed using the trained deep learning model.

Using the trained deep learning model, key features may be extracted from an input bloodstain image, and pattern classification of the bloodstain image may be performed based on the key features.

The pattern classification of the bloodstain image may include the classification system based on the formation mechanism of bloodstains or the morphological classification system of bloodstains.

In operation 280, the bloodstain pattern classification device 10 may output a classification result.

Operation 280 of outputting the classification result may include an operation of respectively displaying results of the pattern classification of the bloodstain image (e.g., classification based on a formation mechanism of bloodstains or morphological classification of bloodstains). For example, classification results by the classification system based on the formation mechanism of bloodstains and the morphological classification system of bloodstains may be output step by step.

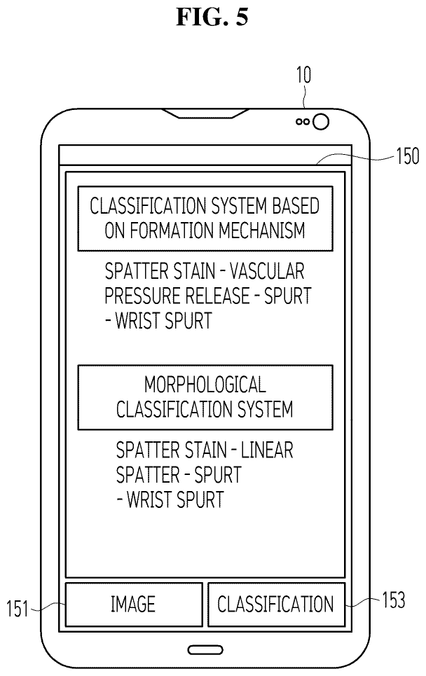

FIG. 5 is a view illustrating an output of a display according to an embodiment.

For example, referring to FIG. 5, a classification result for a specific bloodstain image may be displayed on the display 150. When a user selects a bloodstain image by an ‘image’ button 151 and classifies it by a ‘classification’ button 153, it can be displayed as ‘classification system based on formation mechanism: spatter stain-vascular pressure release-spurt-wrist spurt’ and ‘morphological classification system: spatter stain-linear spatter-spurt-wrist spurt’.

As another example, a GUI may include highlighting a node corresponding to the classification result for the specific bloodstain image on a logic tree. Highlighting a node may be expressed by changing the color of the node or changing the configuration of the node (node shape, font size, etc.). In addition, highlighting can be done by expanding/reducing the size of the node. Accordingly, users may check where the classification result is located on the logic tree.

The bloodstain pattern classification method 20 using deep learning according to various embodiments illustrated in FIG. 4 can be written as computer programs and can be implemented in general-use digital computers that execute the programs using a non-transitory computer-readable recording medium. The non-transitory computer-readable recording medium may be a magnetic storage medium (e.g., read-only memory (ROM), a floppy disk, a hard disk, etc.), or an optical reading medium (e.g., a CD ROM, a digital versatile disk (DVD) or the like).

According to an embodiment, bloodstain pattern classification may be easily performed when observing bloodstains at a crime scene, thereby contributing to reducing fatigue of experts, increasing analysis speed, and improving accuracy when analyzing a crime scene.

According to an embodiment, bloodstain pattern classification may be performed in a multifaceted manner by performing classification by a classification system based on a formation mechanism and a morphological classification system.

The description herein is for describing the disclosure and numerous modifications and adaptations will be readily apparent to one of ordinary skill in the art without departing from the spirit and scope of the disclosure. For example, the relevant results may be achieved even when the described technologies are performed in a different order than the described methods, and/or even when the described elements such as systems, structures, devices, and circuits are coupled or combined in a different form than the described methods or are replaced or substituted by other elements or equivalents.

Accordingly, while the disclosure has been particularly shown and described with reference to embodiments thereof, it will be understood that various changes in form and details may be made therein without departing from the spirit and scope of the following claims.

What is claimed is:

1. A bloodstain pattern classification method using deep learning, the bloodstain pattern classification method comprising:
obtaining a plurality of bloodstain images;
classifying and labeling the obtained bloodstain images based on a predefined classification system;
generating a bloodstain image database by storing the classified and labeled bloodstain images;
extracting training data and validation data from the bloodstain image database and separating them according to a preset ratio;
performing deep learning model training using the training data;
performing validation of the trained deep learning model using the validation data; and
performing pattern classification of the bloodstain images using the trained deep learning model,
wherein the predefined classification system comprises a classification system based on a formation mechanism of bloodstains or a morphological classification system of bloodstains.

2. The bloodstain pattern classification method of claim 1, wherein the bloodstain images comprise an original bloodstain image and an extended bloodstain image.

3. The bloodstain pattern classification method of claim 2, wherein the extended bloodstain image is generated by dividing the original bloodstain image into a plurality of sections and applying an opacity filter to the divided bloodstain image.

4. The bloodstain pattern classification method of claim 1, further comprising:
outputting a result of the pattern classification of the bloodstain images.

5. The bloodstain pattern classification method of claim 1, comprising:
performing additional training of the trained deep learning model using an additional bloodstain image based on a validation result of the trained deep learning model.

6. The bloodstain pattern classification method of claim 1, wherein the classification system based on the formation mechanism of bloodstains comprises:
classification 1-1, which classifies a bloodstain into a spatter stain and a non-spatter stain;
classification 1-2, which classifies the spatter stain according to a formation mechanism of gravity, external force dispersion, vascular pressure release, and cast-off, and classifies the non-spatter stain according to a formation mechanism of surface action and transfer;
classification 1-3, which classifies a bloodstain caused by the gravity into a drip, drip trail, and blood into blood, classifies a bloodstain caused by the external force dispersion into an impact spatter stain and expectorate spatter, classifies a bloodstain caused by the vascular pressure release into a spurt, gush, splash pattern, and arterial spatter, classifies a bloodstain caused by the cast-off into a cast-off pattern,
classifies a bloodstain caused by the surface action into a pool, flow pattern, and saturation stain, and classifies a bloodstain caused by the transfer into a contact stain; and
classification 1-4, which classifies the impact spatter stain into a blunt impact spatter stain and a gun impact spatter stain, classifies the spurt into a wrist spurt and a carotid spurt, classifies the cast-off pattern into a swing cast-off pattern and a cessation cast-off pattern, wherein the cessation cast-off pattern is classified into a forward cessation cast-off pattern and a back cessation cast-off pattern, and classifies the contact stain into a pattern transfer, irregular pattern transfer, and smear, wherein the smear is classified into a wipe pattern and a swipe pattern.

7. The bloodstain pattern classification method of claim 1, wherein the morphological classification system of bloodstains comprises:
classification 2-1, which classifies a bloodstain into a spatter stain and a non-spatter stain according to bloodstain pattern features;
classification 2-2, which classifies the spatter stain into a linear spatter and a non-linear spatter according to whether bloodstains are distributed linearly, and classifies the non-spatter stain into an irregular margin and regular margin according to whether the margins are regular;
classification 2-3, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer; and
classification 2-4, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

8. A bloodstain pattern classification device using deep learning, the bloodstain pattern classification device comprising:
at least one memory storing at least one instruction; and
at least one processor,
wherein the at least one processor is configured to execute the at least one instruction to:
obtain a plurality of bloodstain images;
classify and label the obtained bloodstain images based on a predefined classification system;
generate a bloodstain image database by storing the classified and labeled bloodstain images;
extract training data and validation data from the bloodstain image database and separate them according to a preset ratio;
perform deep learning model training using the training data;
perform validation of the trained deep learning model using the validation data; and
perform pattern classification of the bloodstain images using the trained deep learning model,
wherein the predefined classification system comprises a classification system based on a formation mechanism of bloodstains or a morphological classification system of bloodstains.

9. The bloodstain pattern classification device of claim 8, wherein the bloodstain images comprise an original bloodstain image and an extended bloodstain image.

10. The bloodstain pattern classification device of claim 9, wherein the extended bloodstain image is generated by dividing the original bloodstain image into a plurality of sections and applying an opacity filter to the divided bloodstain image.

11. The bloodstain pattern classification device of claim 8, wherein the at least one processor is configured to execute the at least one instruction to:
output a result of the pattern classification of the bloodstain images.

12. The bloodstain pattern classification device of claim 8, wherein the at least one processor is configured to execute the at least one instruction to:
perform additional training of the trained deep learning model using an additional bloodstain image based on a validation result of the trained deep learning model.

13. The bloodstain pattern classification device of claim 8, wherein the classification system based on the formation mechanism of bloodstains comprises:
classification 1-1, which classifies a bloodstain into a spatter stain and a non-spatter stain;
classification 1-2, which classifies the spatter stain according to a formation mechanism of gravity, external force dispersion, vascular pressure release, and cast-off, and classifies the non-spatter stain according to a formation mechanism of surface action and transfer;
classification 1-3, which classifies a bloodstain caused by the gravity into a drip, drip trail, and blood into blood, classifies a bloodstain caused by the external force dispersion into an impact spatter stain and expectorate spatter, classifies a bloodstain caused by the vascular pressure release into a spurt, gush, splash pattern, and arterial spatter, classifies a bloodstain caused by the cast-off into a cast-off pattern,
classifies a bloodstain caused by the surface action into a pool, flow pattern, and saturation stain, and classifies a bloodstain caused by the transfer into a contact stain; and
classification 1-4, which classifies the impact spatter stain into a blunt impact spatter stain and a gun impact spatter stain, classifies the spurt into a wrist spurt and a carotid spurt, classifies the cast-off pattern into a swing cast-off pattern and a cessation cast-off pattern, wherein the cessation cast-off pattern is classified into a forward cessation cast-off pattern and a back cessation cast-off pattern, and classifies the contact stain into a pattern transfer, irregular pattern transfer, and smear, wherein the smear is classified into a wipe pattern and a swipe pattern.

14. The bloodstain pattern classification device of claim 8, wherein the morphological classification system of bloodstains comprises:
classification 2-1, which classifies a bloodstain into a spatter stain and a non-spatter stain according to bloodstain pattern features;
classification 2-2, which classifies the spatter stain into a linear spatter and a non-linear spatter according to whether bloodstains are distributed linearly, and classifies the non-spatter stain into an irregular margin and a regular margin according to whether the margins are regular;
classification 2-3, which classifies the linear spatter into a spurt, swing cast-off pattern, drip trail, and cessation cast-off pattern (linear),
classifies the non-linear spatter into a non-drip and a drip based on the presence or absence of radial distribution, wherein the non-drip is classified into an expectorate spatter and a non-expectorate spatter based on the presence or absence of small rings and bubbles, wherein the non-expectorate spatter is classified into an impact spatter stain and a cessation cast-off pattern (non-linear) based on the presence or absence of circular or oval bloodstains,
classifies the irregular margin into a smear and a non-smear based on the presence or absence of a spatter stain or spine, wherein the non-smear is classified into blood into blood, a gush, and a splash pattern, and the smear is classified into a wipe pattern and a swipe pattern based on the presence or absence of a pre-existing bloodstain, and
classifies the regular margin into a pattern transfer, saturation stain, flow pattern, pool, and irregular pattern transfer; and
classification 2-4, which classifies the spurt into a wrist spurt and a carotid spurt, classifies the impact spatter stain into a blunt impact spatter stain and a gun impact spatter stain, and classifies the cessation cast-off pattern (non-linear) into a forward cessation cast-off pattern and a back cessation cast-off pattern.

15. A computer program stored on a non-transitory computer-readable storage medium for executing the method of claim 1 using a computer.
